(19) United States
(12) Patent Application Publication
(10) Pub. No.: US 2019/0145446 A1
(43) Pub. Date: May 16, 2019

(54) INTEGRATED FIXTURE RETENTION MECHANISM

(71) Applicant: FORD GLOBAL TECHNOLOGIES, LLC, Dearborn, MI (US)

(72) Inventor: Eric Bowman, Livonia, MI (US)

(21) Appl. No.: 15/809,025

(22) Filed: Nov. 10, 2017

(51) Int. Cl. F16B 3/00

(52) U.S. Cl. CPC F16B 3/00; B60N 2/46

(57) ABSTRACT

A retention system for temporarily joining vehicle elements to one another includes a first vehicle element integral meshing surface and a second vehicle element integral cooperating meshing surface. The first vehicle element integral meshing surface and the second vehicle element integral cooperating meshing surface are adapted to engage one another to at least temporarily prevent separation of the first vehicle element from the second vehicle element. The integral meshing surface and integral cooperating meshing surface may each be defined by meshing tooth structures. The plurality of meshing tooth structures may be disposed in an aligned configuration. The system finds use in joining vehicle elements such as wrapped armrest trim pieces and armrests during vehicle assembly. Methods for temporarily joining vehicle elements using the described retention system are provided.

### TECHNICAL FIELD

The present disclosure generally relates to retainers for securing vehicle elements one to another. More specifically, the present disclosure relates to an integrated fixture retention mechanism adapted to secure a first vehicle element to a second vehicle element during an assembly process, keeping the first and second vehicle elements at least temporarily together during assembly until they can be permanently fastened.

### BACKGROUND

During assembly, it is desirable to hold certain adjoining vehicle elements together as the assembly process proceeds but prior to application of a permanent fastening means such as mechanical fasteners, permanent adhesive, and the like. If the adjoining vehicle elements present perfect mating surfaces, this is a relatively simple process. However, in other situations one or the other of the adjoining vehicle elements may be subject to separating forces or inertias. As an example, during assembly a wrapped door trim piece may be required to be held adjacent to an armrest piece prior to a final attachment step such as by adhesive and/or a mechanical fastener. However, the door trim wrap, being compressible, tends to exert a separating force against the armrest piece.

Accordingly, there is identified a need in the art for improved structures for retaining vehicle elements in an adjoining orientation during the assembly process and prior to application of permanent fastening means.

### SUMMARY

In accordance with the purposes and benefits described herein, in one aspect of the present disclosure a retention system for joining vehicle elements is provided, comprising a first vehicle element integral meshing surface and a second vehicle element integral cooperating meshing surface. The first vehicle element integral meshing surface and the second vehicle element integral cooperating meshing surface are adapted to engage one another to at least temporarily prevent vertical separation of the joined first vehicle element and second vehicle element. The retention system further includes a retaining element carried by one or both of the first vehicle element and the second vehicle element, the retaining element being adapted to at least temporarily retain the engagement of the integral meshing surface with the integral cooperating meshing surface and to prevent lateral separation of the first vehicle element and the second vehicle element.

In one possible embodiment, the meshing surface comprises at least one meshing tooth structure. In another possible embodiment, the meshing surface comprises a plurality of aligned meshing tooth structures.

In another aspect of the disclosure, a vehicle fixture assembly is provided, comprising a first vehicle element integral meshing surface, a second vehicle element integral cooperating meshing surface, and a retaining element substantially as described above. The first vehicle element may be a wrapped trim piece for a vehicle armrest. The second vehicle element may be a vehicle armrest.

In one possible embodiment, the meshing surface comprises at least one meshing tooth structure. In another possible embodiment, the meshing surface comprises a plurality of aligned meshing tooth structures.

In yet another aspect, a method for connecting adjoining vehicle elements is provided, comprising providing a first vehicle element including an integral meshing surface, providing a second vehicle element including an integral cooperating meshing surface, and aligning the first vehicle element to the second vehicle element whereby the integral meshing surface engages the integral cooperating meshing surface to at least temporarily prevent vertical separation of the joined first vehicle element and second vehicle element. The method may include a later step of connecting the first vehicle element to the second vehicle element by one or more additional fasteners. The first and second vehicle element may include a retaining element adapted to at least temporarily retain the engagement of the integral meshing surface with the integral cooperating meshing surface and to prevent a lateral separation of the first vehicle element from the second vehicle element. The first vehicle element may be a wrapped trip piece for a vehicle armrest, and the second vehicle element may be a vehicle armrest.

In one possible embodiment, the method includes providing the meshing surface comprising at least one meshing tooth structure. In another possible embodiment, the method includes providing the meshing surface comprising a plurality of aligned meshing tooth structures.

In the following description, there are shown and described embodiments of the disclosed integrated fixture retention mechanism. As it should be realized, the described devices are capable of other, different embodiments and their several details are capable of modification in various, obvious aspects all without departing from the systems and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed integrated fixture retention mechanism, and together with the description serve to explain certain principles thereof. In the drawings:

FIG. 1 shows a wrapped trim piece secured to a vehicle door and armrest assembly;

FIG. 2 shows a trim piece and armrest including an integrated fixture retention mechanism according to the present disclosure;

FIG. 3 shows cooperating meshing surfaces for the integrated fixture retention mechanism of FIG. 2;

FIG. 4 shows an embodiment of a first vehicle element comprising an integral meshing surface;

FIG. 5 shows an alternative embodiment of a first vehicle element comprising an integral meshing surface; and

FIG. 6 shows an embodiment of a second vehicle element comprising a cooperating integral meshing surface.

Reference will now be made in detail to embodiments of the disclosed integrated fixture retention mechanism, examples of which are illustrated in the accompanying drawing figures.

### DETAILED DESCRIPTION

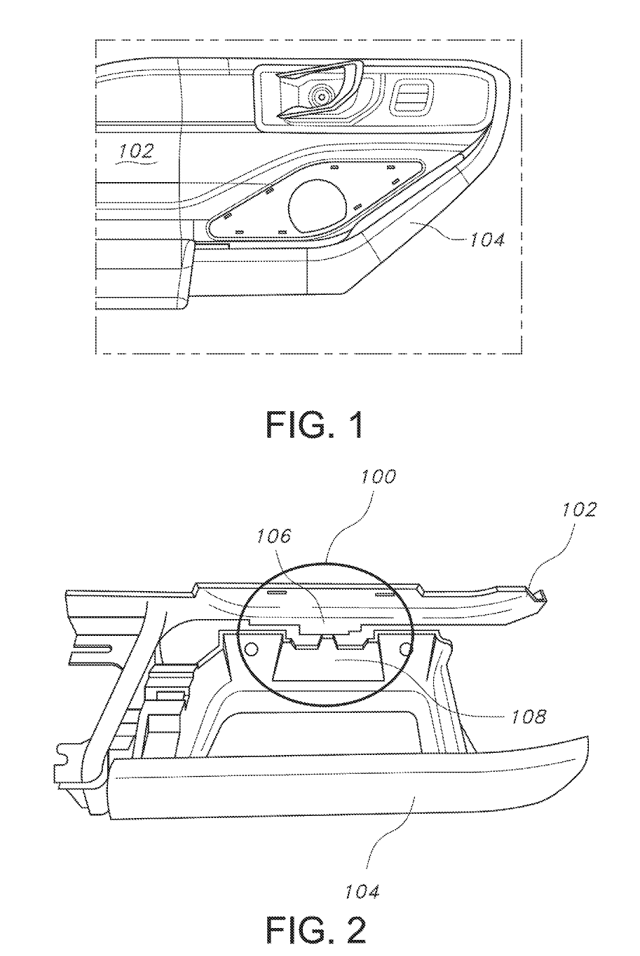

With reference to FIG. 1, the present disclosure is directed to an integrated fixture retention mechanism 100 (not visible in this view) for at least temporarily retaining a first vehicle element 102 to a second vehicle element 104 during an assembly process. In the depicted embodiment, the first vehicle element 102 is a wrapped trim piece configured for attachment to a vehicle door and/or armrest, and the second vehicle element 104 is a vehicle armrest. However, it will be appreciated that the described integrated fixture retention mechanism 100 is readily adaptable to any adjoining vehicle elements required to be at least temporarily adjoined to one another prior to application of a permanent joining means during an assembly process.

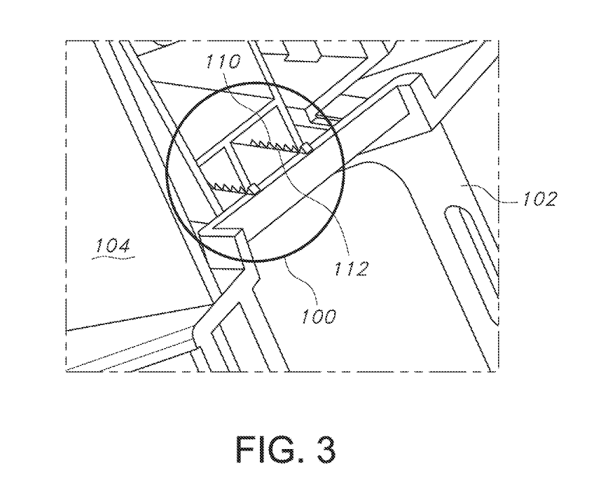

With reference to FIG. 2, the first vehicle element 102 includes an integral meshing surface 106, and the second vehicle element 104 includes an integral cooperating meshing surface 108. As shown in FIG. 3, in an embodiment the integral meshing surface 106 and the integral cooperating meshing surface 108 each comprise meshing teeth 110, 112, typically disposed in a coplanar aligned configuration.

In use the first vehicle element 102 may be aligned with and joined to the second vehicle element 104 (see FIG. 1) whereby the integral meshing surface 106 and integral cooperating meshing surface 108 likewise join one to another whereby at least a portion of the meshing teeth 110, 112 interlock (see FIG. 3), at least temporarily preventing inadvertent vertical separation of the first vehicle element from the second vehicle element. In that manner, the first vehicle element 102 is retained in an adjoined configuration with the second vehicle element 104 until such time as a more permanent connector (not shown) may be used, such as an adhesive or a mechanical fastener.

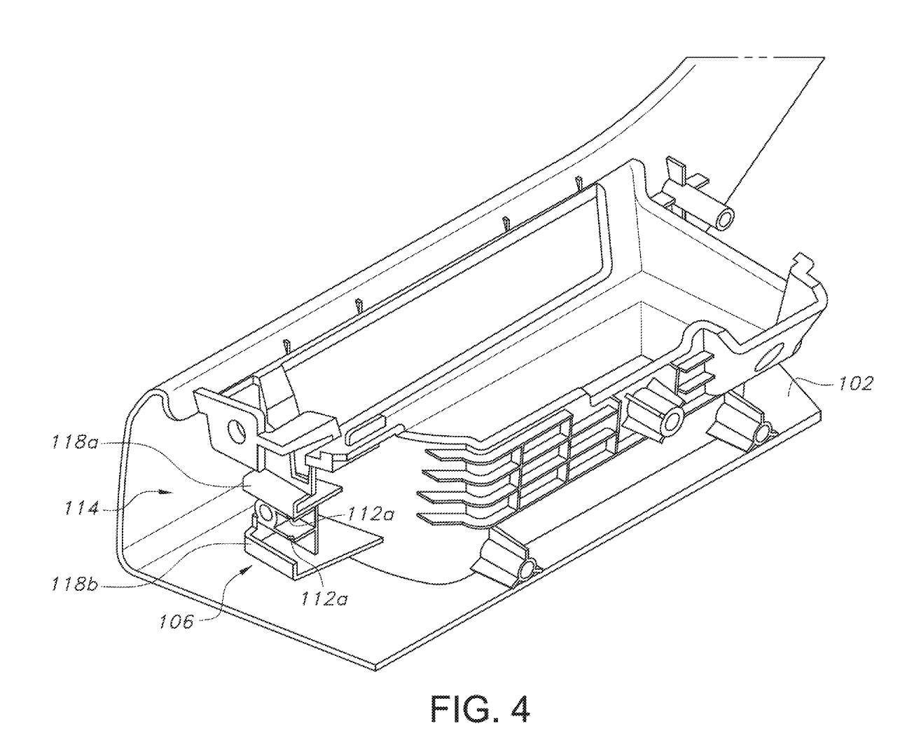

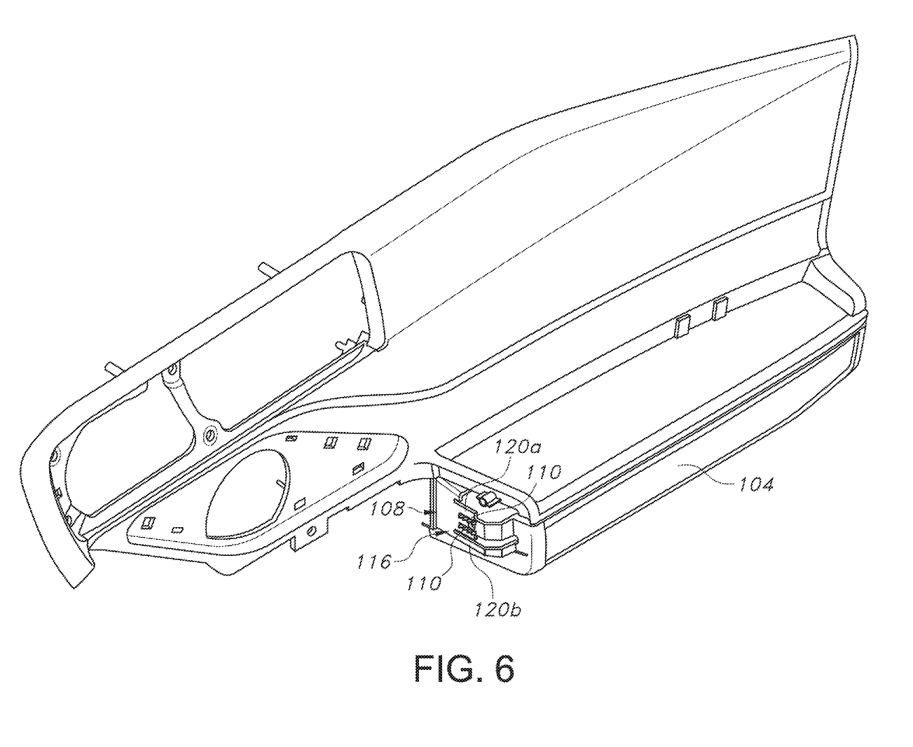

In more detail, with reference to FIG. 4 showing an embodiment of a first vehicle element 102, a retaining element 114 is provided which engages a cooperating retaining element 116 (not shown) carried by the second vehicle element 104. In the depicted embodiment, the retaining element 114 comprises a pair of angled walls 118a, 118b which slidingly engage the second vehicle element 104 retaining element 116 (not visible in this view, but see FIG. 6 showing a retaining element 116 which comprises a pair of flanges 120a, 120b), thus preventing or controlling lateral movement of the first vehicle element 102 and second vehicle element 104 relative to one another, and also providing a snug adjoining fit of integral meshing surface 106 and integral cooperating meshing surface 108.

As described above, in embodiments the integral meshing surface 106 and the integral cooperating meshing surface 108 (not visible in this view) each comprise meshing teeth 110 (not visible in this view), 112. In one possible embodiment (see FIG. 4), the integral meshing surface 106 comprises a single meshing tooth 112a. As will be described, slidingly joining the first vehicle element 102 to the second vehicle element 104 (not visible in this view) whereby the respective retaining elements 114, 116 slidingly engage one another concurrently causes the meshing tooth 112a to engage meshing teeth 110, thus at least temporarily preventing vertical movement of the first vehicle element 102 and second vehicle element 104 relative to one another. Because the integral meshing surface 106 comprises a single meshing tooth, the connection between the first vehicle element 102 and second vehicle element 104 is substantially releasable.

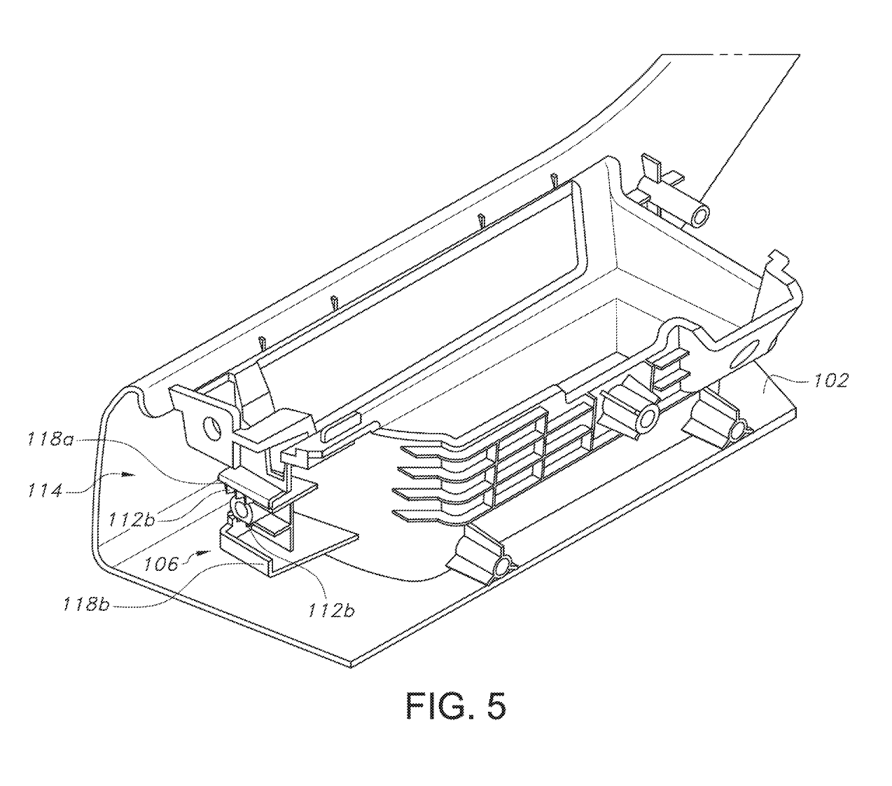

In another possible embodiment (see FIG. 5), the integral meshing surface 106 comprises a plurality of meshing teeth 112b, provided as a pair of parallelly oriented sets (one set partially obscured in the drawing figure) of meshing teeth 112b arrayed in a coplanar aligned configuration. As will be appreciated, slidingly joining the first vehicle element 102 to the second vehicle element 104 (not visible in this view) whereby the respective retaining elements 114, 116 slidingly engage one another concurrently causes the plurality of meshing teeth 110 (not visible in this view) to engage the plurality of meshing teeth 112b, thus at least temporarily preventing vertical movement of the first vehicle element 102 and second vehicle element 104 (not visible in this view) relative to one another. Because the integral meshing surface 106 and the integral cooperating meshing surface 108 each comprise a plurality of meshing teeth, the connection between the first vehicle element 102 and second vehicle element 104 is substantially irreversible.

With reference to FIG. 6, the second vehicle element 104 includes a retaining element 116 comprising flanges 120a, 120b configured to slidingly engage the angled walls 118a, 118b. The retaining element 116 further carries a plurality of meshing teeth 110, in the depicted embodiment being provided as a pair of parallelly oriented sets of meshing teeth 110 arrayed in a coplanar aligned configuration. As will be appreciated, slidingly joining the first vehicle element 102 (not visible in this view) to the second vehicle element 104 whereby the respective resilient members 120a, 120b slidingly abut one another concurrently causes the meshing teeth 110 to engage meshing teeth 112a or 112b (depending on the embodiment of first vehicle element 102), thus at least temporarily preventing vertical movement of the first vehicle element 102 and second vehicle element 104 relative to one another.

As will be appreciated, by the above-described integrated fixture retention mechanism 100, the first vehicle element 102 is at least temporarily joined to the second vehicle element 104. So, as one non-limiting example, in an embodiment where the first vehicle element 102 is a wrapped trim piece and the second vehicle element 104 is an armrest, the tendency for the wrap portion of the wrapped vehicle element 102 to cause the two elements to separate is overcome. Thus, as the assembly comprising the first and second vehicle elements 102, 104 proceeds down an assembly line to a station where a permanent fastener such as adhesive and/or a mechanical fastener is applied, separation or misalignment of the two elements during this process and potential future problems in assembly are not a concern.

Obvious modifications and variations are possible in light of the above teachings. All such modifications and variations are within the scope of the appended claims when interpreted in accordance with the breadth to which they are fairly, legally and equitably entitled.

What is claimed:

1. A retention system for joining vehicle elements, comprising:
a first vehicle element integral meshing surface; and
a second vehicle element integral cooperating meshing surface;
the first vehicle element integral meshing surface and the second vehicle element integral cooperating meshing surface being adapted to engage one another to at least temporarily prevent vertical separation of the joined first vehicle element and second vehicle element.

2. The system of claim 1, further including a retaining element carried by one or both of the first vehicle element and the second vehicle element, the retaining element being adapted to at least temporarily retain an engagement of the integral meshing surface with the integral cooperating meshing surface and to prevent lateral separation of the first vehicle element and the second vehicle element.

3. The system of claim 2, wherein the meshing surface comprises at least one meshing tooth structure.

4. The system of claim 2, wherein the meshing surface comprises a plurality of aligned meshing tooth structures.

5. A vehicle fixture assembly, comprising:
a first vehicle element integral meshing surface; and
a second vehicle element integral cooperating meshing surface; and
a retaining element adapted to prevent lateral separation of a joined first vehicle element and second vehicle element;
the integral meshing surface and integral cooperating meshing surfaces being adapted to engage one another to at least temporarily prevent vertical separation of the joined first vehicle element and second vehicle element.

6. The assembly of claim 5, wherein the retaining element is further adapted to retain an engagement of the integral meshing surface with the integral cooperating meshing surface.

7. The assembly of claim 6, wherein the integral meshing surface comprises at least one meshing tooth structure.

8. The assembly of claim 6, wherein the integral meshing surface comprises a plurality of meshing tooth structures.

9. The assembly of claim 5, wherein the first vehicle element is a wrapped trim piece for a vehicle armrest.

10. The assembly of claim 5, wherein the second vehicle element is a vehicle armrest.

11. A method for connecting adjoining vehicle elements, comprising:
providing a first vehicle element including an integral meshing surface; and
providing a second vehicle element including an integral cooperating meshing surface;
aligning the first vehicle element to the second vehicle element whereby the integral meshing surface engages the integral cooperating meshing surface to at least temporarily prevent vertical separation of a joined first vehicle element and second vehicle element.

12. The method of claim 11, including providing a retaining element adapted to at least temporarily retain an engagement of the integral meshing surface with the integral cooperating meshing surface and to prevent a lateral separation of the first vehicle element from the second vehicle element.

13. The method of claim 11, further including a later step of connecting the first vehicle element to the second vehicle element by one or more additional fasteners.

14. The method of claim 11, including providing the integral meshing surface comprising at least one meshing tooth structure.

15. The method of claim 11, including providing the integral meshing surface comprising a plurality of meshing tooth structures.

16. The method of claim 11, including providing the first vehicle element configured as a wrapped trim piece for a vehicle armrest.

17. The method of claim 11, including providing the second vehicle element configured as a vehicle armrest.
